(19) United States
(12) Patent Application Publication
(10) Pub. No.: US 2015/0054220 A1
(43) Pub. Date: Feb. 26, 2015

(54) Game Apparatus and Method of Play

(71) Applicant: Anthony James BROWN, Tallebudgera, Queensland (AU)

(72) Inventor: Anthony James Brown, Tallebudgera (AU)

(21) Appl. No.: 14/389,465

(22) PCT Filed: Mar. 28, 2013
(86) PCT No.: PCT/AU2013/000334

§ 371 Date: Sep. 30, 2014

(30) Foreign Application Priority Data
Mar. 30, 2012 (AU) 2012901284

(51) Int. Cl. G07F 17/32; A63F 1/00

(52) U.S. Cl. CPC G07F 17/3293; A63F 1/00; G07F 17/3258; A63F 2001/001
USPC 273/292; 463/11

(57) ABSTRACT

A game apparatus including at least one processor with memory to store and process instructions, at least one visual display device to display a generated image of a playing surface according to the instructions processed by the at least one processor, the generated image adjusted by the at least one processor according to the instructions which include rules of a game based on Baccarat in which a wager can be placed on either a Player hand or a Banker hand to win or tie between the Player hand and Banker and further including at least one area on the generated image for each player of the game to place an ante wager on a first card dealt and displayed in the Player hand, in order to allow the player the option of proceeding or withdrawing based on the first card dealt and displayed in the Player hand.

### TECHNICAL FIELD

The present invention relates to game apparatus and also a method for playing a game.

### BACKGROUND ART

Conventional Baccarat is a comparing card game played between two hands, the “player” and the “banker.” Each Baccarat coup has three possible outcomes: “player” (player has the higher score), “banker,” and “tie.”

In Baccarat, cards 2-9 are worth their face value, 10s and J, Q K are worth zero, and Aces are worth 1 point. Hands are valued according to the rightmost digit of the sum of their constituent cards: for example, a hand consisting of 2 and 3 is worth 5, but a hand consisting of 6 and 7 is worth 3 (the rightmost digit of the total, 13). The highest possible hand value is 9. In the game, a “Baccarat” refers to anything with a value of zero; in a hand of K, 4 and 6, the King is a “Baccarat,” and the hand value is also “Baccarat.”

The overwhelming majority of casino Baccarat games in the United States, United Kingdom, Canada, Australia, Sweden, Finland, and Macau, are a version called “Punto banco” Baccarat. In Punto banco, the casino banks the game at all times, and commits to playing out both hands according to fixed drawing rules, known as the “tableau”, in contrast to more historic Baccarat games where each hand is associated with an individual who makes drawing choices. Player (“Punto”) and Banker (“banco”) are simply designations for the two hands dealt out in each coup, two outcomes which the bettor can back; Player has no particular association with the customer, nor Banker with the house.

Punto banco is dealt from a shoe containing 4, 6 or 8 decks of cards shuffled together. A cut-card is placed in front of at least seven cards from the rear of the shoe but a more commonly used number of cards is 16, and the drawing of the cut-card indicates the last coup of the shoe. For each coup, two cards are dealt face up to each hand, starting from “player” and alternating between the hands. The croupier may call the total (e.g. “Five Player, three Banker”). If either Player or Banker or both achieve a total of 8 or 9 at this stage, the coup is finished and the result is announced: Player win, a Banker win, or tie. If neither hand has eight or nine, the drawing rules are applied to determine whether Player should receive a third card. Then, based on the value of any card drawn to the player, the drawing rules are applied to determine whether the Banker should receive a third card. The coup is then finished, the outcome is announced and winning bets are paid out.

If neither the Player nor Banker is dealt a total of 8 or 9 in the first two cards (known as a “natural”), the tableau is consulted, first for Player's rule, then Banker's rule.

Player's Rule:

If Player has an initial total of 0-5, he draws a third card. If Player has an initial total of 6 or 7, he stands.

Banker's Rule:

If Player stood pat (i.e., has only two cards), the Banker regards only his own hand and acts according to the same rule as Player. That means Banker draws a third card with hands 0-5 and stands with 6 or 7. If Player drew a third card, the Banker acts according to the following more complex rules:
If Player drew a 2 or 3, the Banker draws with 0-4, and stands with 5-7.
If Player drew a 4 or 5, the Banker draws with 0-5, and stands with 6-7.
If Player drew a 6 or 7, the Banker draws with 0-6, and stands with 7.
If Player drew an 8, the Banker draws with 0-2, and stands with 3-7.
If Player drew an ace, 9, 10, or face-card, the Banker draws with 0-3, and stands with 4-7.
   The casinos list these rules in a more easily remembered format as follows:
If the banker total is 2 or less then banker draws a card, regardless of what the player's third card is.
If the banker total is 3 then the bank draws a third card unless the player's third card was an 8.
If the banker total is 4 then the bank draws a third card if the player's third card was 2, 3, 4, 5, 6, 7.
If the banker total is 5 then the bank draws a third card if the player's third card was 4, 5, 6, or 7.
If the banker total is 6 then the bank draws a third card if the player's third card was a 6 or 7.
If the banker total is 7 then the banker stands.
The croupier will deal the cards according to the tableau and the croupier will announce the winning hand: either Player or Banker. Losing bets will be collected and the winning bets will be paid according to the rules of the house. Usually, even money or 1-1 will be paid on Player bets and 95% to Banker bets (even money with “5% commission to the house”).
Should both Banker and Player have the same value at the end of the deal the croupier shall announce “egalité—tie bets win.” all tie bets will be paid at 8 to 1 odds and all bets on Player or Banker remain in place and active for the next game (the customer may or may not be able to retract these bets depending on casino rules).

It will be clearly understood that, if a prior art publication is referred to herein, this reference does not constitute an admission that the publication forms part of the common general knowledge in the art in Australia or in any other country.

### SUMMARY OF INVENTION

The present invention is directed to a game apparatus and a method for playing a game which may at least partially overcome at least one of the abovementioned disadvantages or provide the consumer with a useful or commercial choice.

With the foregoing in view, the present invention in one form, resides broadly in a game apparatus including at least one processor with memory to store and process instructions, at least one visual display device to display a generated image of a playing surface according to the instructions processed by the at least one processor, the generated image adjusted by the at least one processor according to the instructions which include rules of a game based on Baccarat in which a wager can be placed on either a Player hand or a Banker hand to win or tie between the Player hand and Banker and further including at least one area on the generated image for each player of the game to, place an ante wager on a first card dealt and displayed in the Player hand, in order to allow the player the option of proceeding or withdrawing based on the first card dealt and displayed in the Player hand.

In an alternative form, the present invention resides in a method of game play game based on Baccarat in which a wager can be placed on either a Player hand or a Banker hand to win or tie between the Player hand and Banker hand in a coup using an apparatus including at least one processor with memory to store and process instructions, and at least one visual display device to display a generated image of a playing surface according to the instructions processed by the at least one processor including the steps of:
a) generating and displaying a first image of a playing surface including at least one area on the generated image for each player of the game to place an ante wager on either the Player hand or the Banker hand based on a first card dealt and displayed in the Player hand prior to an initial wagering step;
b) generating and displaying a second image of a playing surface including a portion of the generated image indicating a first card image dealt to the Player hand;
c) allowing the player the option of proceeding or withdrawing from the coup based on the first card dealt and displayed in the Player hand, if proceeding, requiring a further wager of a particular amount to be made by a continuing player who has placed an ante wager, the further wager displayed in the generated image of the playing surface; and
d) generating and displaying one or more subsequent images of the playing surface based on normal play of the coup in the Baccarat game;
e) generating and displaying one or more result images of the playing surface based on a player winning or losing the coup according to drawing rules of Baccarat; and
f) paying winning bets according to a payout regime including payout of the ante wager if made and if the coup is won to a designated account of each player,
   wherein the generated images are generated and displayed substantially in real time by the at least one processor according to the instructions.

In yet another form, the invention resides in a method of game play game based on Baccarat with a plurality of cards in which a wager can be placed on either a Player hand or a Banker hand to win or tie between the Player hand and Banker hand in a coup using a game table apparatus including a playing surface including at least one area for each player of the game to place an ante wager on either the Player hand or the Banker hand based on a first card dealt and displayed in the Player hand prior to an initial wagering step, the method including the steps of:
a) Allowing each player of the game to place an ante wager on either the Player hand or the Banker hand prior to an initial wagering step
b) Dealing at least a first card dealt to the Player hand;
c) allowing the player the option of proceeding or withdrawing from the coup based on the first card dealt in the Player hand, if proceeding, requiring a further wager of a particular amount to be made by a continuing player who has placed an ante wager, the further wager to be placed in a particular portion of the playing surface;
d) playing out the coup in the Baccarat game according to drawing rules of Baccarat;
e) resolving a result of the coup according to drawing rules of Baccarat; and
f) paying winning bets according to a payout regime including payout of the ante wager if made and if the coup is won.

The game of the present invention is based on a modified game of Baccarat. In particular, the rules of the game of the present invention are such that one or more ante bets can be made before each coup of the game begins on the Player hand and/or the Banker hand before a wager is required. However, if an ante bet is made, and the player decides to continue play in the coup, then a wager of a particular quantum must be made. Normally the particular quantum is twice the amount of the ante bet for which the player is continuing.

Typically, the player will be required to decide whether to continue with the coup or fold after the first card is dealt to the Player hand. Alternatives exist wherein the “play/fold” decision of a player who has made an ante bet can be required after the first card is dealt to the Banker hand (typically after the after the first card is dealt to the Player hand).

The game of the present invention as with normal Baccarat is preferably played with multiple decks of cards, typically eight decks, with no jokers included.

Depending upon the particular embodiment, the decks of cards will be physical for a table game, dealt from a shoe or similar and will involve the use of a “cut card” which will signal the end of the shoe. Typically, rules will be provided for the shuffling of the cards once the shoe has finished. In a particularly preferred embodiment, at the start of a new shoe, the dealer will display one card dealt from the shoe. This will determine how many cards the dealer will not use, or “burn” according to the Baccarat value except that a 10 or face card will result in 10 cards being burned. The cut card, which is normally a plastic spacer or similar will be placed approximately 16 cards from the bottom of the shoe. Multiple coups are dealt from the shoe until the cut card appears. When the cut card appears, the dealer will preferably complete that coup, play one more and then start a new shoe. If the cut card is dealt instead of the first card, the dealer will finish that coup and then start a new shoe.

Where the game is implemented electronically, the processor and memory will typically produce a pool of virtual cards based on the cards to be included in a number of decks of cards, and play of the game will be conducted on the basis of each pool of virtual cards comprising a virtual shoe from which cards are dealt until the shoe is finished. The virtual shoe will be finished in a manner similar to that which arises in physical play, namely when a certain number of cards are left in the virtual shoe and/or a predetermined number of coups are played once a “cut card” has been dealt or reached.

Typically, a random generation device will be used to select a “card” from the available pool of “cards” with cards being dealt from the virtual shoe being removed from the pool as they are electrically dealt. Typically, an image of each card dealt will be displayed on the generated image of the playing surface as they are dealt from the virtual shoe.

The dealing of the cards, whether virtual or physical, will preferably occur in a similar fashion to conventional Baccarat and according to particular rules. In a conventional Baccarat game, the rules which govern to whom and how many cards are dealt is known as the “tableau” and the same tableau will preferably govern the dealing of the cards in the game of the present invention whether virtual or physical.

Prior to the play of each round of play or coup, players or users in the game can place at least one, and typically a number of reward tokens indicating a respective investment or wager on the Player hand, the Banker hand, a tie between the Player hand and the Banker hand, ante (on either or both of the Player hand and the Banker hand) or any other one or more predictive possibilities.

After all bets are placed, the dealer preferably deals two cards each to the Player and the Banker. After the first card dealt to the Player hand, ante players or any player that has placed an ante wager, are asked to play or fold.

If the player chooses to fold, the ante wager is forfeited to the house and is collected. The player then typically takes no further part in the coup unless they have other wagers which are still pending.

The remainder of the game play for the particular coup is substantially similar to gameplay of a normal Baccarat game. The score of the Player and Banker hands is the right digit of the total of the cards. For example, if the two cards were an 8 and 7, then the total would be 15 and the score would be a 5. The scores will always range from 0 to 9 and it is impossible to bust.

A third card may or may not be dealt to either the Player or the Banker depending on the following rules:

If either the Player or the Banker has a total of an 8 or a 9 they both stand. This rule will preferably override all other rules.

If the Player's total is 5 or less, then the Player hits, otherwise the Player stands.

If the Player stands, then the Banker hits on a total of 5 or less. If the Player hits, the drawing rules, one form of which is illustrated in the chart below, are preferably used to determine if the Banker hits (H) or stand (S):

Baccarat Drawing Rules

| Banker's | Player's Third Card | | | | | | | | | |
|---|---|---|---|---|---|---|---|---|---|---|
| Score | 0 | 1 | 2 | 3 | 4 | 5 | 6 | 7 | 8 | 9 |
| 7 | S | S | S | S | S | S | S | S | S | S |
| 6 | S | S | S | S | S | S | H | H | S | S |
| 5 | S | S | S | S | H | H | H | H | S | S |
| 4 | S | S | H | H | H | H | H | H | S | S |
| 3 | H | H | H | H | H | H | H | H | S | H |
| 2 | H | H | H | H | H | H | H | H | H | H |
| 1 | H | H | H | H | H | H | H | H | H | H |
| 0 | H | H | H | H | H | H | H | H | H | H |

The score of the Player and Banker are compared; the winner is the one that is greater. Winning bets on the Banker pay 1-1, (If the Banker wins with a pair, Banker wins 1-2). Winning bets on the Player pay 1 to 1, winning bets on a tie pay 8 to 1. In the event of a tie, Banker and Player bets will push.

Preferably, a number of predictive bets or wagers can be made by the players in the game. Possible examples are included in the table below:

| | |
|---|---|
| Player | Wins if Player or Banker hand is the winner. Pays 1-1 |
| Banker | If the winning hand is Banker and contains a pair, Banker bets will be |
| | paid 1-2 instead of 1-1. |
| Tied Game | A bet that the Banker and Player hand will be a tie. Pays 8-1 |
| Red or Black | Wins if the winning hand has more Red or Black Cards. Pays 1-1 |
| | If Red/Black is a tie, stake is returned. |
| | If the winning hand is Banker and contains a pair, Red/Black bets pay |
| | 1-2 and the Tie returns 50% of the stake. |
| Player/Banker Pair | Wins if the winning hand contains a pair - Pays 15-1. |
| Player/Banker Bad | Wins if the losing hand has a 0 score. Pays 9-1 |
| Beat | |
| Player/Banker | Wins if the winning hand has a score of 8 or 9 in the first two cards. |
| Natural | Pays 4-1 |

Typically, the payout made to a player who wins during a particular coup will depend upon the total of the value of the cards dealt to either the Player or Banker, whichever hand wins. The payout will typically be determined according to the score of the winning hand. A variety of payout odds can be used.

There is typically an electronic or virtual implementation of the game of the present invention as well as a table embodiment.

In the table embodiment, a physical table having a playing surface on an upper surface is typically provided and the game is played relative to the playing surface. The playing surface is preferably generally rectangular although it could be any other shape.

The playing surface will preferably be divided into a number of portions or stations which are each individually delineated to be easily identified by each player as well as including indicia which identify the nature of the wager made in each respective betting station as well as the quantum of the payout if successful.

The playing surface is typically divided generally in half, with each half including either the Player hand portions or stations or the Banker hand portions or stations.

Preferably, a plurality of player or user stations will be located about three of the four preferred side edges of the playing surface. Typically, the fourth preferred side edge is reserved for the dealer of the cards or the house in order to control play and award or recover reward tokens won or lost during gameplay by each player or user.

There will typically further be a number of predictive wager stations provided on the playing surface in a central location. Preferably, the central portion of the playing surface will be a community portion accessible by all players or users. Typically, the community portion will also be divided into predictive wager stations relating to either the Player hand or the Banker hand.

Typically, the predictive wager stations will be mirrored in each half of the playing surface namely all of the predictive wager stations in a particular half are related to either the Player hand or the Banker hand depending upon the side of the central dividing line that the predictive wager station lays.

Typically, there will be a priority of different predictive wager stations relating to different possible occurrences in relation to the particular cards dealt during each coup.

Normally, the stations on the playing surface may be coloured or shaded or filled in different manners in order to clarify the relationship between the respective stations or to distinguish between the different stations.

Preferably, there will be at least one ante wagering station associated with each of the Player and Banker in each player or user station. The ante wagering station is preferably printed on or relative to the playing surface of the table or is included in the generated image of the playing surface in the electronic or virtual embodiment. However, in the table embodiment, the ante wagering station may be a station which is provided separately from the playing surface. For example, a conventional Baccarat playing surface can be provided with a retrofit ante wagering station for each player in a form which is not printed or applied to the playing surface but is provided in a form which allows use of the conventional Baccarat playing surface but implementing the ante wagering option of the present invention. One form in which an ante wagering station could be provided as a retrofit to a conventional Baccarat playing surface is as a sticker or similar applied to the playing surface or a separate mat or the like.

Normally, in this embodiment, wagers are physically placed by each player or user, by moving one or more reward tokens into or onto the corresponding station.

According to the electronic or virtual embodiment of the game of the present invention, the game will be played using a processor, memory containing instructions and a display in order to display the playing surface and changes to the playing surface brought about by changes in the status of the game.

The playing surface will be as discussed above but instead of a physical table having the playing surface, the playing surface will be a virtual playing surface which is generated as an image and which image changes according to changes in the game.

Any processor may be used but typically, the processor, memory and display will be integrated in a single body such as in a mobile telephone or similar device, computer including a desktop, notebook, netbook, ultra book or any other type or a personal computing device of any type. It is also anticipated that the game can be hosted remotely and provided that a device has a communications pathway associated with it, the device can be or include a display and the processor and memory for hosting the game can be located remotely with information conveyed to the display generating an image on the display.

Therefore, in this embodiment, the game can be delivered in an online environment over a computer network such as the Internet, an internal or more defined network or on an individual machine. The game can be played on a slave machine or on a standalone machine having all of the requirements to run the standalone game.

The memory provided may be of any type. The memory will typically allow the designation of a portion of memory for identification of the “cards” in a virtual shoe of cards by inclusion in a pool. As mentioned above, a random generation selector device will typically be used to select cards from the pool to be dealt from the virtual shoe with those cards then being removed from the pool or otherwise marked or designated so that they are not used again until the virtual shoe is finished and a new shoe or pool is initiated.

Preferably, the display and more particularly, the generation of the image to be displayed on the display device is powered or driven by the processor.

Typically, the processing of instructions stored in the memory according to actions taken place or initiated by a user or player of the game will cause a transformation of the displayed image of the playing surface and the displayed playing surface image thereby changes with changes to the game according to the actions taken by the player in terms of placing wagers and also changes due to the dealing of cards according to the rules of the game.

Typically, the display changes in mil time as changes to the image to be displayed are required due to gameplay and driven by the processor in order to accurately represent the state of play in the game at any particular time.

A message may be displayed overlaid on the playing surface image when particular actions are taking place in the game such as for example when the virtual shoe is being shuffled or renewed.

In an alternative embodiment, the invention resides in a software product on a storage medium which implements a method of game play game based on Baccarat in which a wager can be placed on either a Player hand or a Banker hand to win or tie between the Player hand and Banker hand in a coup using an apparatus including at least one processor with memory to store and process instructions, and at least one visual display device to display a generated image of a playing surface according to the instructions processed by the at least one processor including the steps of generating and displaying a first image of a playing surface including at least one area on the generated image for each player of the game to place an ante wager on either the Player hand or the Banker hand based on a first card dealt and displayed in the Player hand prior to an initial wagering step, generating and displaying a second image of a playing surface including a portion of the generated image indicating a first card image dealt to the Player hand, allowing the player the option of proceeding or withdrawing from the coup based on the first card dealt and displayed in the Player hand, if proceeding, requiring a further wager of a particular amount to be made by a continuing player who has placed an ante wager, the further wager displayed in the generated image of the playing surface, and generating and displaying one or more subsequent images of the playing surface based on normal play of the coup in the Baccarat game, generating and displaying one or more result images of the playing surface based on a player winning or losing the coup according to drawing rules of Baccarat, and paying winning bets according to a payout regime including payout of the ante wager if made and if the coup is won to a designated account of each player, wherein the generated images are generated and displayed substantially in real time by the at least one processor according to the instructions.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 is a schematic view of a playing surface (electronically generated and displayed or a on a playing table) according to a preferred embodiment of the present invention.

FIG. 2 is a schematic view of an electronically implemented embodiment of the present invention according to a preferred embodiment.

### DESCRIPTION OF EMBODIMENTS

According to a particularly preferred embodiment of the present invention, a game apparatus and method of play is provided.

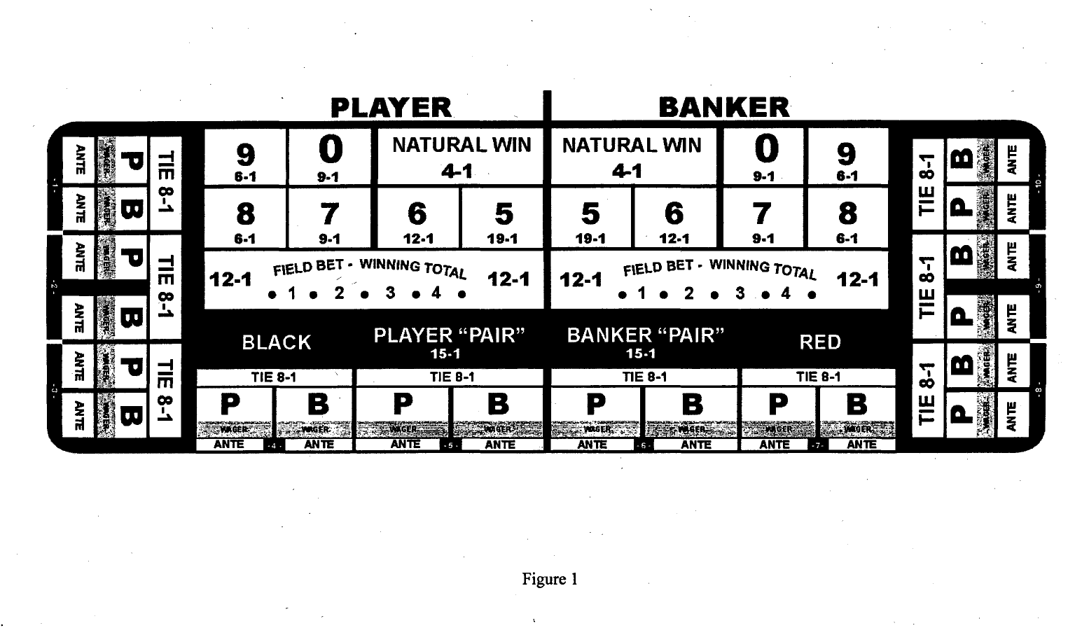

In one preferred embodiment, the invention is directed to a table game played on a table, one example of which is illustrated in FIG. 1.

In the table embodiment, a physical table having a playing surface on an upper surface is typically provided and the game is played relative to the playing surface. The playing surface is preferably generally rectangular although it could be any other shape.

The playing surface will preferably be divided into a number of portions or stations which are each individually delineated to be easily identified by each player as well as including indicia which identify the nature of the wager made in each respective betting station as well as the quantum of the payout if successful.

The playing surface is typically divided generally in half, with each half including either the Player hand portions or stations or the Banker hand portions or stations.

Preferably, a plurality of player or user stations will be located about three of the four preferred side edges of the playing surface. Typically, the fourth preferred side edge is reserved for the dealer of the cards or the house in order to control play and award or recover reward tokens one or lost during gameplay by each player or user.

There will typically further be a number of predictive wager stations provided on the playing surface in a central location. Preferably, the central portion of the playing surface will be a community portion accessible by all players or users. Typically, the community portion will also be divided into predictive wager stations relating to either the Player hand or the Banker hand.

Typically, the predictive wager stations will be mirrored in each half of the playing surface number all of the predictive wager stations in a particular half are related to either the Player hand or the Banker hand depending upon the side of the central providing online that the predictive way to station lies.

Typically, there will be a priority of different predictive wager stations relating to different possible occurrences in relation to the particular cards dealt during each coup.

Normally, the stations on the playing surface may be coloured or shaded or filled in different manners in order to clarify the relationship between the respective stations or to distinguish between the different stations.

Preferably, there will be at least one ante wagering station associated with each of the Player and Banker in each player or user station.

Normally, in this embodiment, wagers are physically placed by each player or user, by moving one or more reward tokens into or onto the corresponding station.

The method of play uses 8 regular decks of cards with no jokers. The game is dealt in a similar fashion to regular Baccarat and cards are drawn using the same table of play. Bets may be placed on Player/Banker ante wager station to win, or on the outcome of the hand, before the first Player card has been dealt and displayed. The ante and wager are detailed below.

Ante and Wager

| ANTE | This is an interactive bet that can be made prior to any cards being dealt. It | |
|---|---|---|
| | is betting that either the Player or Banker hand will win. | |
| | Once the initial one card has been displayed for the player hand, the player | |
| | is asked to play or fold. If they fold, they forfeit the ante wager. | |
| | If they play, they must place double the amount of the ante wager in the | |
| | station marked Player bet or Banker bet relating to their original ante | |
| | wager. A player may not change from one station (Player or Banker) to the | |
| | other. | |
| WAGER | The second bet is known as the wager. | |
| | If the hand wins, the ante bet wins preferably 1-1. | |
| | If the hand wins, the wager is also paid, preferably at the following odds: | |
| | If the losing hand is a total of 0 -1-2 - 3 | Pays 1 to 2 |
| | If the losing hand is a total of 4-5 | Pays 1 to 1 |
| | If the losing hand is a total of 6-7-8 | Pays 2 to 1 |

There is preferably no commission on any bets mentioned above.

Cards are given point values as follows: Ace=1, 2-9=pip value, 10 and face card=0.

At the start of a new shoe, the dealer will turn over one card. This will determine how many cards the dealer will burn, according to the Baccarat value, except a 10 or face card will result in 10 cards burned.

The cut card will be placed 16 cards from the bottom of the shoe. When the cut card appears, the dealer will finish that hand, play one more hand, and then start a new shoe. If the cut card comes out instead of the first card, the dealer will finish that hand, and then start a new shoe.

Play begins by all players betting either on the “player”, “banker”, tie or an ante bet on either (or both) Player hand and Banker hand or the predictive bets described below.

After all bets are down, the dealer gives two cards each to the player and the banker (after the first card dealt to the Player hand, ante bettors will be asked to play or fold). The score of the hand is the right digit of the total of the cards. For example, if the two cards were an 8 and 7, then the total would be 15 and the score would be a 5. The scores will always range from 0 to 9 and it is impossible to bust.

A third card may or may not be dealt to either the player or the dealer depending on the following rules:

If either the player or the banker has a total of an 8 or a 9 they both stand. This rule overrides all other rules.

If the player's total is 5 or less, then the player hits, otherwise the player stands.

If the player stands, then the banker hits on a total of 5 or less. If the player hits, use the chart below to determine if the banker hits (H) or stand (S):

Baccarat Drawing Rules

| Banker's | Player's Third Card | | | | | | | | | |
|---|---|---|---|---|---|---|---|---|---|---|
| Score | 0 | 1 | 2 | 3 | 4 | 5 | 6 | 7 | 8 | 9 |
| 7 | S | S | S | S | S | S | S | S | S | S |
| 6 | S | S | S | S | S | S | H | H | S | S |
| 5 | S | S | S | S | H | H | H | H | S | S |
| 4 | S | S | H | H | H | H | H | H | S | S |
| 3 | H | H | H | H | H | H | H | H | S | H |
| 2 | H | H | H | H | H | H | H | H | H | H |
| 1 | H | H | H | H | H | H | H | H | H | H |
| 0 | H | H | H | H | H | H | H | H | H | H |

The score of the player and dealer are compared; the winner is the one that is greater. Winning bets on the banker pay 1-1, (If the banker wins win a pair, Banker wins 1-2). Winning bets on the player pay 1 to 1, winning bets on a tie pay 8 to 1. In the event of a tie, banker and player bets will push.

All predictive bets detailed below, must be placed before any cards are dealt and may not be changed or removed during the game.

| | |
|---|---|
| Player | Wins if Player or Banker hand is the winner. Pays 1-1 |
| Banker | If the winning hand is Banker and contains a pair, Banker bets will be |
| | paid 1-2 instead of 1-1. |
| Tied Game | A bet that the Banker and Player hand will be a tie. Pays 8-1 |
| Red or Black | Wins if the winning hand has more Red or Black Cards. Pays 1-1 |
| | If Red/Black is a tie, stake is returned. |
| | If the winning hand is Banker and contains a pair, Red/Black bets pay |
| | 1-2 and the Tie returns 50% of the stake. |
| Player/Banker Pair | Wins if the winning hand contains a pair - Pays 15-1. |
| Player/Banker Bad | Wins if the losing hand has a 0 score. Pays 9-1 |
| Beat | |
| Player/Banker | Wins if the winning hand has a score of 8 or 9 in the first two cards. |
| Natural | Pays 4-1 |

The bettor can choose to bet on the outcomes of the game for Player or Banker. These wagers would typically be won by a player if the winning hand has the following scores:

| Winning Score | Pays |
|---|---|
| 1, 2, 3 or 4 | 12-1 |
| 5 | 19-1 |
| 6 | 12-1 |
| 7 | 9-1 |
| 8 | 6-1 |
| 9 | 6-1 |

In an alternative embodiment, the invention is directed to an electronic game played on a displayed playing surface, one example of which is illustrated in FIG. 1.

According to the electronic or virtual embodiment of the game of the present invention, the game will be played using a processor, memory containing instructions and a display in order to display the playing surface and changes to the playing surface brought about by changes in the status of the game.

The playing surface will be as discussed above but instead of a physical table having the playing surface, the playing surface will be a virtual playing surface which is generated as an image and which image changes according to changes in the game.

Any processor may be used but typically, the processor, memory and display will be integrated in a single body such as in a mobile telephone or similar device, computer including a desktop, notebook, netbook, ultra book or any other type or a personal computing device of any type. It is also anticipated that the game can be hosted remotely and provided that a device has a communications pathway associated with it, the device can be or include a display and the processor and memory for hosting the game can be located remotely with information conveyed to the display generating an image on the display.

Therefore, in this embodiment, the game can be delivered in an online environment over a computer network such as the Internet, an internal or more defined network or on an individual machine. The game can be played on a slave machine or on a standalone machine having all of the requirements to run the standalone game.

The memory provided may be of any type. The memory will typically allow the designation of a portion of memory for identification of the “cards” in a virtual shoe of cards by inclusion in a pool. As mentioned above, a random generation selector device will typically be used to select cards from the pool to be dealt from the virtual shoe with those cards then being removed from the pool or otherwise marked or designated so that they are not used again until the virtual shoe is finished and a new shoe or pool is initiated.

Preferably, the display and more particularly, the generation of the image to be displayed on the display device is powered or driven by the processor.

Typically, the processing of instructions stored in the memory according to actions taken place or initiated by a user or player of the game will cause a transformation of the displayed image of the playing surface and the displayed playing surface image thereby changes with changes to the game, according to the actions taken by the player in terms of placing wagers and also changes due to the dealing of cards according to the rules of the game.

Typically, the display changes in real time as changes to the image to be displayed are required due to gameplay and driven by the processor in order to accurately represent the state of play in the game at any particular time.

Where the game is implemented electronically, the processor and memory will typically produce a pool of virtual cards based on the cards to be included in a number of decks of cards, and play of the game will be conducted on the basis of each pool of virtual cards comprising a virtual shoe from which cards are dealt until the shoe is finished. The virtual shoe will be finished in a manner similar to that which arises in physical play, namely when a certain number of cards are left in the virtual shoe and/or a predetermined number of coups are played once a “cut card” has been dealt or reached.

Typically, a random generation device will be used to select a “card” from the available pool of “cards” with cards being dealt from the virtual shoe being removed from the pool as they are electrically dealt. Typically, an image of each card dealt will be displayed on the generated image of the playing surface as they are dealt from the virtual shoe.

The dealing of the cards, whether virtual or physical, will preferably occur in a similar fashion to conventional Baccarat and according to particular rules. In a conventional Baccarat game, the rules which govern to whom and how many cards are dealt is known as the “tableau” and the same tableau will preferably govern the dealing of the cards in the game of the present invention whether virtual or physical.

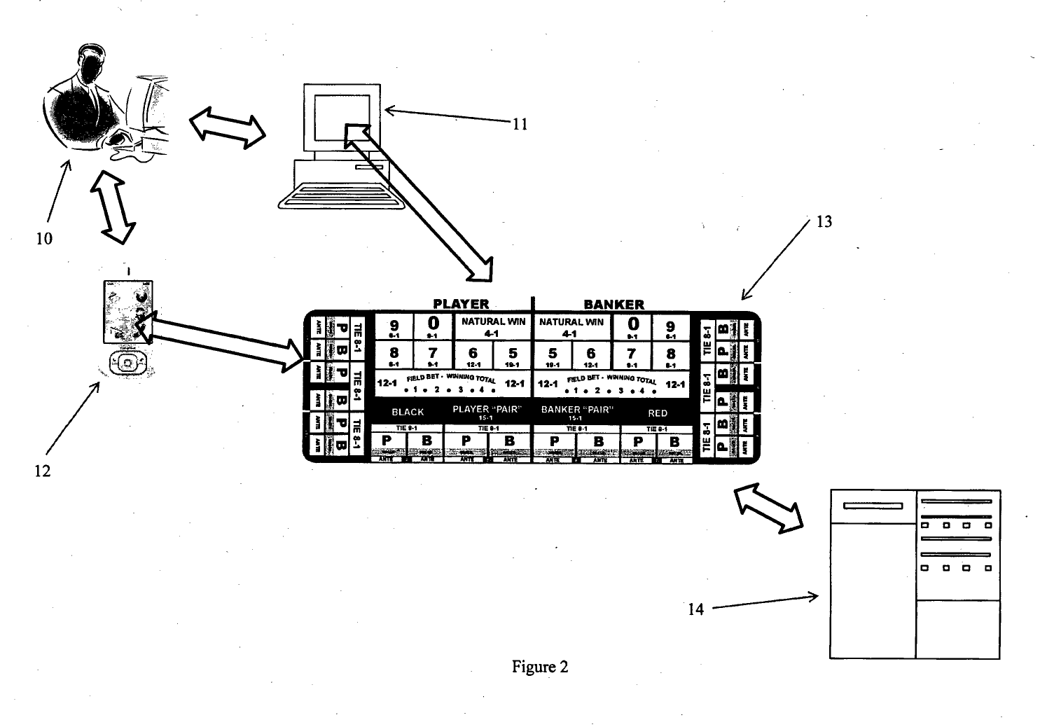

A preferred form of electronic implementation is illustrated in FIG. 2. In the illustrated preferred embodiment, a user 10 will use either a computer 11 or a smart phone 12 to access a web page available over a network of computers that will display a playing surface 13 to the user 10. The user 10 can then use the computer 11 or the smart phone 12 to input wagers based upon interaction between the user 10 and the electronically generated and displayed playing surface 13 using the input devices of the computer 11 or the smart phone 12. Essentially, the user 10 will indicate the quantum of the wagers that they wish to place and the station or stations upon which they wish to place the wager on the playing surface 13.

The electronic implementation of the invention operates to communicate the user's input through interaction with the electronically generated and displayed playing surface 13 to a remote server 14 which accepts the user's input and updates the electronically generated and displayed playing surface 13 in real time to reflect the input, the corresponding changes to the image of the playing surface and the gameplay response to the input according to the rules in the memory of the server. Once user input has been completed, the information reflecting the user input is transmitted to the server 14 from the computer 11 or smartphone 12 either directly or indirectly whereupon the information is processed according to the rules stored in the memory of the server and gameplay proceeds according to those rules with corresponding changes made to the electronically generated and displayed playing surface 13 by the processor of the server according to the rules and which are transmitted to the computer 11 or smart phone 12 to be displayed on those respective items for the user to view. The user can then either further interact with the electronically generated and displayed playing surface 13 in order to complete the gameplay with the gameplay controlled by the user and the rules in place in the memory of the surfer or the gameplay proceeds according to the rules and the electronically generated and displayed playing surface 13 is updated and displayed accordingly.

As indicated by the arrows in FIG. 2, the interaction between the user 10, through the computer 11 or the smart phone 12 with the server 14 is at two way interaction, with information according to the user's desires transmitted from the user 10 to the server 14 via the input of the user through the electronically generated and displayed playing surface 13 which is then processed by the server according to the rules and new information in relation to a new image reflecting the up to date gameplay electronically generated by the server and forwarded to the computer 11 or the smart phone 12 for display of the playing surface thereon.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A game apparatus including table having a playing surface on an upper surface divided into a number of stations which are each individually delineated to be easily identified by each player, indicia which identify the nature of a wager made in each respective betting station as well as a quantum of a payout to be made to a player if successful and at least one area on the playing surface for each player of the game to place an ante wager on a first card dealt and displayed in a Player hand, in order to allow the player the option of proceeding or withdrawing from a coup based on the first card dealt and displayed in the Player hand.

2. A game apparatus according to claim 1 wherein the playing surface is divided generally in half, with each half including either a Player hand stations or a Banker hand stations.

3. A game apparatus according to claim 1 or 2 wherein a plurality of player stations are located about all but one portion of a side edge of the playing surface which is reserved for a dealer of the cards in order to control play and award or recover wagers won or lost during gameplay by each player.

4. A game apparatus according to any one of the preceding claims further including a number of predictive wager stations provided on the playing surface in a community portion accessible by all players.

5. A game apparatus according to claim 4 wherein the community portion is also divided into predictive wager stations relating to either a Player hand or a Banker hand.

6. A game apparatus according to claim 4 wherein the predictive wager stations are mirrored in each half of the playing surface namely all of the predictive wager stations in a particular half are related to either the Player hand or the Banker hand depending upon the side of a central dividing line that a particular predictive wager station lays.

7. A game apparatus according to claim 5 or 6 wherein a priority of predictive wager stations is provided relating to different possible occurrences in relation to the cards dealt during each coup.

8. A game apparatus according to any one of the preceding claims wherein the stations on the playing surface are coloured, shaded or filled in different manners in order to clarify a relationship between the stations or to distinguish between stations.

9. A game apparatus according to any one of the preceding claims wherein at least one ante wagering station associated with each of a Player and a Banker in each player station are provided.

10. A game apparatus according to claim 9 wherein the ante wagering stations are printed on the playing surface of the table.

11. A game apparatus according to claim 9 wherein the ante wagering stations are provided separately from the playing surface as a retrofit ante wagering station.

12. A method of game play based on Baccarat with a plurality of cards in which a wager can be placed on either a Player hand or a Banker hand to win or tie between the Player hand and Banker hand in a coup using a game table apparatus including a playing surface including at least one area for each player of the game to place an ante wager on either the Player hand or the Banker hand based on a first card dealt and displayed in the Player hand prior to an initial wagering step, the method including the steps of:
a) Allowing each player of the game to place an ante wager on either the Player hand or the Banker hand prior to an initial wagering step
b) Dealing at least a first card dealt to the Player hand;
c) allowing the player the option of proceeding or withdrawing from the coup based on the first card dealt in the Player hand, if proceeding, requiring a further wager of a particular amount to be made by a continuing player who has placed an ante wager, the further wager to be placed in a particular portion of the playing surface;
d) playing out the coup in the Baccarat game according to drawing rules of Baccarat;
e) resolving a result of the coup according to drawing rules of Baccarat; and
f) paying winning bets according to a payout regime including payout of the ante wager if made and if the coup is won.

13. A game apparatus including at least one processor with memory to store and process instructions, at least one visual display device to display a generated image of a playing surface according to the instructions processed by the at least one processor, the generated image adjusted by the at least one processor according to the instructions which include rules of a game based on Baccarat in which a wager can be placed on either a Player hand or a Banker hand to win or tie between the Player hand and Banker and further including at least one area on the generated image for each player of the game to place an ante wager on a first card dealt and displayed in the Player hand, in order to allow the player the option of proceeding or withdrawing based on the first card dealt and displayed in the Player hand.

14. A method of game play based on Baccarat in which a wager can be placed on either a Player hand or a Banker hand to win or tie between the Player hand and Banker hand in a coup using an apparatus including at least one processor with memory to store and process instructions, and at least one visual display device to display a generated image of a playing surface according to the instructions processed by the at least one processor including the steps of:
a) generating and displaying a first image of a playing surface including at least one area on the generated image for each player of the game to place an ante wager on either the Player hand or the Banker hand based on a first card dealt and displayed in the Player hand prior to an initial wagering step;
b) generating and displaying a second image of a playing surface including a portion of the generated image indicating a first card image dealt to the Player hand;
c) allowing the player the option of proceeding or withdrawing from the coup based on the first card dealt and displayed in the Player hand, if proceeding, requiring a further wager of a particular amount to be made by a continuing player who has placed an ante wager, the further wager displayed in the generated image of the playing surface; and
d) generating and displaying one or more subsequent images of the playing surface based on normal play of the coup in the Baccarat game;
e) generating and displaying one or more result images of the playing surface based on a player winning or losing the coup according to drawing rules of Baccarat; and
f) paying winning bets according to a payout regime including payout of the ante wager if made and if the coup is won to a designated account of each player,
wherein the generated images are generated and displayed substantially in real time by the at least one processor according to the instructions.

15. A game apparatus or method as claimed in claim 13 or claim 14 wherein the game is played using a processor, memory containing instructions and a display in order to display the playing surface and changes to the playing surface brought about by changes in the game.

16. A game apparatus or method as claimed in any one of claims 13 to 15 wherein the game is played using a virtual playing surface which is generated as an image by the processor and displayed on the display which image changes according to changes in the game.

17. A game apparatus or method as claimed in any one of claims 13 to 16 wherein the processor and memory produce a pool of virtual cards based on the cards to be included in a number of decks of cards, and play of the game is conducted on the basis of each pool of virtual cards comprising a virtual shoe from which cards are dealt until the virtual shoe is finished.

18. A game apparatus or method as claimed in claim 17 wherein a random generation device is used to select a card from the available pool of virtual cards with cards being dealt from the virtual shoe being removed from the virtual pool as they are electronically selected.

19. A game apparatus or method as claimed in claim 18 wherein an image of each card dealt is displayed on the generated image of the playing surface as they are dealt from the virtual shoe.

20. A game apparatus or method as claimed in any one of claims 13 to 19 wherein the processing of instructions stored in the memory according to actions taken place or initiated by a user or player of the game causes a transformation of the displayed image of the playing surface and the displayed playing surface image thereby changes with changes to the game according to the actions taken by the player in terms of placing wagers and also changes due to the dealing of cards according to the rules of the game.

21. A game apparatus or method as claimed in claim 20 wherein the display changes in real time as changes to the image to be displayed are required due to gameplay and driven by the processor in order to accurately represent the state of play in the game at any particular time.

22. A game apparatus or method as claimed in claim 20 or claim 21 wherein a message is displayed overlaid on the playing surface image when particular actions are taking place in the game

23. A game apparatus or method as claimed in any one of the preceding claims wherein if an ante bet is made, and the player decides to continue play in the coup, then a wager of a particular quantum must be made.

24. A game apparatus or method as claimed in claim 23 wherein the player must decide whether to continue with the coup or fold after the first card is dealt to the Player hand.

25. A game apparatus or method as claimed in claim 23 or claim 24 wherein the player must decide whether to continue with the coup or fold after the first card is dealt to the Banker hand.

26. A game apparatus or method as claimed in any one of the preceding claims wherein the payout made to a player who wins during a particular coup depends upon a total of the value of the cards dealt to either the Player or Banker, whichever hand wins.

27. A software product on a storage medium which implements a method of game play game based on Baccarat in which a wager can be placed on either a Player hand or a Banker hand to win or tie between the Player hand and Banker hand in a coup using an apparatus including at least one processor with memory to store and process instructions, and at least one visual display device to display a generated image of a playing surface according to the instructions processed by the at least one processor including the steps of generating and displaying a first image of a playing surface including at least one area on the generated image for each player of the game to place an ante wager on either the Player hand or the Banker hand based on a first card dealt and displayed in the Player hand prior to an initial wagering step, generating and displaying a second image of a playing surface including a portion of the generated image indicating a first card image dealt to the Player hand, allowing the player the option of proceeding or withdrawing from the coup based on the first card dealt and displayed in the Player hand, if proceeding, requiring a further wager of a particular amount to be made by a continuing player who has placed an ante wager, the further wager displayed in the generated image of the playing surface, and generating and displaying one or more subsequent images of the playing surface based on normal play of the coup in the Baccarat game, generating and displaying one or more result images of the playing surface based on a player winning or losing the coup according to drawing rules of Baccarat, and paying winning bets according to a payout regime including payout of the ante wager if made and if the coup is won to a designated account of each player, wherein the generated images are generated and displayed substantially in real time by the at least one processor according to the instructions.
